(19) United States
(12) Patent Application Publication
(10) Pub. No.: US 2022/0214293 A1
(43) Pub. Date: Jul. 7, 2022

(54) IN-PROCESS PARALLEL PLATE SENSOR SYSTEM FOR ELECTROMAGNETIC IMPEDANCE SPECTROSCOPY MONITORING OF FLUIDS

(71) Applicant: TransTech Systems, Inc., New York, NY (US)

(72) Inventors: Manfred Geier, Oakland, CA (US); Andrew J. Westcott, Troy, NY (US); Adam D. Blot, Altamont, NY (US)

(21) Appl. No.: 17/613,242

(22) PCT Filed: May 20, 2020
(86) PCT No.: PCT/US2020/033683

§ 371 Date: Nov. 22, 2021

Related U.S. Application Data
(60) Provisional application No. 62/851,319, filed on May 22, 2019.

(51) Int. Cl. G01N 27/02; G01N 27/22

(52) U.S. Cl. CPC G01N 27/026; G01N 27/221; G01N 27/028

(57) ABSTRACT

Various aspects relate to characterizing features of a fluid, for example, during a manufacturing process. In particular aspects, a parallel plate sensor system is disclosed that applies an electromagnetic field over a range of frequencies to a fluid as it flows through a piping system. The system is configured to perform in-process characterization of physical attributes of the fluid as it passes through the piping system. In some cases, the system includes: a transmitting electrode assembly having: a transmitting electrode having a transmitting surface; and a transmitting electrode backer ground plate at least partially surrounding the transmitting electrode; a receiving electrode assembly comprising: a receiving electrode having receiving surface, wherein the receiving surface is smaller than the transmitting surface; and a receiving electrode backer ground plate at least partially surrounding the receiving electrode; and a fluid channel between the transmitting electrode assembly and the receiving electrode assembly, the fluid channel permitting transverse flow

### PRIORITY CLAIM

This application claims priority to U.S. Provisional Patent Application No. 62/851,319, filed on May 22, 2019, which is incorporated by reference in its entirety.

### TECHNICAL FIELD

This disclosure relates generally to characterizing features of a fluid. In particular cases, this disclosure presents a sensor system and related approaches for in-process characterization of physical attributes of a fluid.

### BACKGROUND

In U.S. Pat. No. 7,219,024, a system is described for conducting electromagnetic impedance spectroscopy (EIS) to non-invasively determine the in-place compaction (i.e., density) and moisture of various engineering materials, with specific interest in soils. This system uses a manually operated gauge to conduct the testing. U.S. Pat. No. 9,465,061 describes a method of conducting an in-process inspection of solid materials with EIS. There is a need to conduct in-process inspections and characterizations of fluids as suggested by U.S. Pat. Nos. 9,372,183, 9,389,175, and 9,797,855. U.S. Pat. No. 9,389,175 applies an optical detection system, and U.S. Pat. Nos. 9,372,183 and 9,797,855 apply impedance flow cytometry, which counts and characterizes cells. Additional publications discuss various electromagnetic methods of characterizing dairy products (e.g., milk) and other foods such as olive oil, fruits, vegetable oils, cookies, pork, and fish. However, these conventional approaches use a sensor system that is designed for laboratory use or focus on the analysis algorithm. There is a need for a sensor system which can be used in line with the processing of liquids including, for example, dairy, food oils, and industrial fluids.

### SUMMARY

All examples and features mentioned below can be combined in any technically possible way.

Various aspects of the disclosure relate to characterizing features of a fluid, for example, during a manufacturing process. In particular aspects, a parallel plate sensor system is disclosed that applies an electromagnetic field over a range of frequencies to a fluid as it flows through a piping system. The system is configured to perform in-process characterization of physical attributes of the fluid as it passes through the piping system.

In certain particular aspects, a system for measuring an electromagnetic impedance characteristic of a fluid under test (FUT) includes: a transmitting electrode assembly having: a transmitting electrode having a transmitting surface; and a transmitting electrode backer ground plate at least partially surrounding the transmitting electrode; a receiving electrode assembly including: a receiving electrode having receiving surface, wherein the receiving surface is smaller than the transmitting surface; and a receiving electrode backer ground plate at least partially surrounding the receiving electrode; and a fluid channel between the transmitting electrode assembly and the receiving electrode assembly, the fluid channel permitting transverse flow of the FUT relative to both the transmitting electrode and the receiving electrode.

In other particular aspects, a method of measuring an electromagnetic impedance characteristic of a fluid under test (FUT) includes: providing a system having: a transmitting electrode assembly including: a transmitting electrode having a transmitting surface; and a transmitting electrode backer ground plate at least partially surrounding the transmitting electrode; a receiving electrode assembly including: a receiving electrode having receiving surface, wherein the receiving surface is smaller than the transmitting surface; and a receiving electrode backer ground plate at least partially surrounding the receiving electrode; and a fluid channel between the transmitting electrode assembly and the receiving electrode assembly; flowing the FUT through the fluid channel; transmitting a set of electromagnetic signals from the transmitting electrode, through the FUT, to the receiving electrode while flowing the FUT through the fluid channel; and detecting a change in the set of electromagnetic signals from the transmitting electrode to the receiving electrode.

Implementations may include one of the following features, or any combination thereof.

In some aspects, the transmitting electrode is substantially parallel with the receiving electrode, and wherein the transmitting electrode is aligned with the receiving electrode.

In particular cases, the transmitting electrode backer ground plate is electrically grounded and insulated from the transmitting electrode, and wherein the transmitting electrode backer ground plate extends from a plane formed by the transmitting electrode and creates an electrically isolated volume proximate to the transmitting electrode, wherein the receiving electrode backer ground plate is electrically grounded and insulated from the receiving electrode, and wherein the receiving electrode backer ground plate extends from a plane formed by the receiving electrode and creates an electrically isolated volume proximate to the receiving electrode.

In certain implementations, the transmitting surface and the receiving surface are each circular, and wherein a diameter of the transmitting surface is larger than a diameter of the receiving surface.

In particular cases, the transmitting surface and the receiving surface each have a rectangular, elliptical or oval shape, and a major dimension of transmitting surface is larger than a major dimension of the receiving surface.

In some aspects, the transmitting electrode conductive backer ground plate and the receiving electrode conductive backer ground plate are each circular, and wherein the diameter of the transmitting surface is equal to approximately a diameter of the receiving electrode conductive backer ground plate.

In particular implementations, the fluid channel is defined by a set of walls, wherein the set of walls includes a pair of openings, and wherein the transmitting electrode assembly is located in a first one of the pair of openings and the receiving electrode assembly is located in a second one of the pair of openings.

In some aspects, the fluid channel has a rectangular cross-section defined by a set of walls and has an inlet and an outlet. The FUT flows from the inlet to the outlet. In these cases, the transmitting electrode assembly is integral and conforming to one of the walls, and the receiving electrode assembly is integral and conforming to the opposite wall.

In certain cases, a portion of each of the walls proximate to the pair of openings is electrically non-conducting.

In some implementations, the electrically non-conducting portion of each of the walls extends from an upstream extreme edge to a downstream extreme edge of the transmitting electrode backer ground plate and the receiving electrode backer ground plate, respectively.

In particular aspects, the fluid channel has an inlet, and an outlet opposing the inlet, wherein the FUT flows from the inlet to the outlet.

In certain aspects, the FUT includes a liquid or a gas.

In some cases, the FUT includes an organic fluid.

In particular implementations, the organic fluid includes milk

In certain cases, the transmitting electrode assembly includes at least one additional transmitting electrode and wherein the receiving electrode assembly includes at least one additional receiving electrode, and wherein respective electrodes in the transmitting electrode assembly are configured to operate at a single frequency or at distinct frequencies and respective electrodes in the receiving electrode assembly are configured to operate at the single frequency or at the distinct frequencies.

In particular aspects, the system further includes a signal generator/analyzer coupled with the transmitting electrode and the receiving electrode, the signal generator/analyzer including: a generator component configured to initiate transmission of a set of electromagnetic signals from the transmitting electrode, through the FUT, to the receiving electrode; and an analyzer component configured to detect a change in the set of electromagnetic signals from the transmitting electrode to the receiving electrode.

In some cases, the set of electromagnetic signals are transmitted within a frequency range that includes frequencies from approximately 100 Hertz to approximately 100 mega-Hertz as may be appropriate for the FUT of interest.

In certain implementations, the system further includes a computing device coupled with the signal generator/analyzer, wherein the computing device is configured to determine a characteristic of the FUT based upon a change in the set of electromagnetic signals from the transmitting electrode to the receiving electrode.

In particular aspects, determining the characteristic of the FUT includes: determining a difference in an aspect of the set of electromagnetic signals; comparing the difference in the aspect to a predetermined threshold; and determining a characteristic of the FUT based upon the compared difference.

In some implementations, the set of electromagnetic signals define an electromagnetic field including field lines extending between the transmitting electrode and the receiving electrode, and wherein a volume of the electromagnetic field is fixed based upon a diameter of the receiving electrode and a width of the fluid channel.

In particular cases, the field lines in the electromagnetic field are substantially parallel with one another.

In some cases, the method further includes determining a characteristic of the FUT based upon a change in the set of electromagnetic signals from the transmitting electrode to the receiving electrode.

In other particular aspects, a parallel plate sensor system for producing a parallel electromagnetic field perpendicular to the flow of a fluid under test (FUT) is disclosed. The parallel plate sensor system can include: a rectangular pipe which is in physical contact with the FUT; a circular transmitting electrode assembly on one side of the electrically non-conducting pipe, the transmitting electrode assembly having: a circular transmitting electrode with a transmitting surface; and a cylindrical transmitting conductive electrode backer ground plate at least partially surrounding the transmitting electrode, the transmitting electrode backer ground plate being electrically grounded and insulated from the transmitting electrode, wherein the transmitting conductive electrode backer ground plane extends from a plane formed by the transmitting electrode and creates an electrically isolated volume proximate to the transmitting electrode; and a circular receiving electrode assembly at the second side of the electrically non-conducting pipe, the receiving electrode assembly having: a circular receiving electrode with a receiving surface, wherein the receiving electrode is parallel with the transmitting electrode and the centers of the electrodes are perpendicular: and a cylindrical receiving electrode conductive backer ground plane at least partially surrounding the receiving electrode, the receiving electrode conductive backer ground plane being electrically grounded and insulated from the receiving electrode, wherein the receiving electrode conductive backer ground plane extends from a plane formed by the receiving electrode and extends into the plane and being coplanar with the receiving electrode, and creates an electrically isolated volume proximate to the receiving electrode; and wherein the diameter of the transmitting surface of the transmitting electrode is larger than the diameter of the receiving surface of the receiving electrode and approximately equal to the diameter of the receiving electrode conductive backer ground plate.

In some of these aspects, the sensor electrodes are in electrical conducting contact with the FUT.

In particular implementations, wherein the sensor electrodes are in non-electrical conducting contact with the FUT.

In certain of these aspects, the FUT is a liquid or gas, and where the FUT is a liquid, that liquid is an organic fluid, and where that liquid is an organic fluid, the organic fluid is milk

In some of these cases, multiple sensors are arranged along the flow direction and each operate at a single frequency or subsets of the range of frequencies of interest for the FUT.

In particular ones of these aspects, the parasitic impedances of the enclosed capacitive volumes are optimized by selection of d_{T} and d_{R} to isolate and control the effects of the field lines which emanate from both the transmitting electrode and the receiving electrode and go to the backer ground plate, and the field lines that pass through the FUT and go to the backer ground plate.

In certain of these implementations, the piping in the area of the sensors are constructed of a non-conducting surface which extends upstream and downstream of the sensors by a distance at least twice the largest dimension of the fluid channel in the region where the sensors are located.

As noted herein, various aspects of the disclosure provide methods for the in-process characterization of fluids through a sensor system that provides for electromagnetic impedance spectroscopy (EIS). In some cases, the sensor system includes a parallel plate sensor with a transmitting and receiving electrodes. The sensor system provides for the generation of parallel electromagnetic field line perpendicular to the flow of the FUT. The electromagnetic signals are generated over a range of frequencies appropriate to the FUT. In certain cases, the frequencies selected fall within the range of 100 Hz to 100 MHz. The resultant measured impedance spectrum is correlated with a specific physical characteristic(s) of the FUT to create algorithms that relates a specific impedance-frequency pattern with the specified physical characteristic(s).

The parallel-plate sensor system can enable the generation of an electromagnetic field with a fixed volume defined by the area of the receiving electrode and the width of the flow channel. This permits the volume of the FUT to be clearly defined, as well as the area of the measurement and the distance the electromagnetic signal travels.

The parallel plate sensor system may be comprised of a single transmitting and receiving electrode sensor pair through which the entire range of frequencies are transmitted. Alternately, multiple sensor pairs may be used each transmitting a single frequency or subsets of the total range of frequencies desired for the specific FUT.

In some cases, the parallel plate sensor system is comprised of a circular transmitting electrode that is larger in diameter than the receiving electrode. In certain other cases, the transmitting electrode is rectangular, elliptical, or oval-shaped. The transmitting electrode has a conductive backer ground plate which acts as the back plane of the transmitting electrode which at least partially surrounds and encloses a volume proximate to the electrode. The receiving electrode has a conductive backer ground plate that extends from the front plane of the electrode which at least partially surrounds and encloses a volume proximate to the receiving electrode. The transmitting electrode's diameter is larger than the receiving electrode's in order to control the electric field lines passing through the FUT from the transmitting electrode to the receiving electrode. The transmitting dimension (e.g., diameter) is approximately equal to the diameter of the receiving conductive backer ground plate.

The parallel plate sensor system can be mounted in a rectangular (e.g., square) flow channel. In an embodiment, the walls of the flow channel are constructed of or lined with a non-conducting material. The walls of the container may be constructed of a conducting material as long as there is a non-conducting liner such that the FUT is not in electrical contact with the walls of the container. The non-conducting surface can extend upstream and downstream of the sensors by a distance at least twice the largest dimension of the flow channel in the region where the sensors are located. Additionally, in some cases, the electrodes and the conductive backer ground plate are electrically isolated from the container and from each other. The walls of the interior and the sensor surfaces form a smooth surface without any perturbations or gaps.

The transmitting and receiving sensor electrodes may be connected to transmitting and receiving connections of a specifically designed signal generating and analyzing circuit, for example, as shown in U.S. Patent Application 62/661,682 (incorporated by reference in its entirety), and in FIG. 3 herein. The signal generating and analyzing functions may also be provided by methods known in the art such as an LCR Meter such as the Keysight E4980A LCR/Impedance Analyzer or an Impedance Analyzer such as the Keysight E9990A Impedance Analyzer. In various cases, the conductive backer ground plate of the transmitting and receiving electrode are connected to the system ground of the signal generator (means).

In certain cases, the transmitting and receiving sensor electrodes are in conducting electrical contact with the FUT.

In certain other cases, the transmitting and receiving sensor electrodes are in non-conducting electrical contact with the FUT.

In some cases, the electrically non-conducting container or liner may include plastics such as polyethylene, polyvinyl chloride (PVC), polytetrafluoroethylene (Teflon), poly carbonate, and various fiber glass reinforce epoxy laminate materials (e.g. FR-4). In some cases, the electrically non-conducting container is formed of a poly methyl methacrylate (PMMA or acrylic), which is substantially transparent and allows for visual observation of the testing process.

The FUT may be an inorganic fluid, an organic fluid (e.g. milk, olive oil, etc.), and/or a biological fluid (e.g. blood). In addition to liquids, the FUT may also be gaseous.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

The embodiments of this disclosure will be described in detail, with reference to the following figures, wherein like designations denote like elements, and wherein:

FIG. 1 shows a top view and a side sectional view (AA) of a parallel plate sensor system installed in a fluid channel, with a side view of the fluid channel.

FIG. 2 is a front sectional view (BB) of the parallel plate sensor system installed in the fluid channel of FIG. 1.

FIG. 3 is the side sectional view (AA) of the parallel plate sensor system of FIG. 1, further illustrating electromagnetic field lines.

FIG. 4 shows a front sectional view (BB) of the parallel plate sensor system of FIG. 1, with additional illustration of attachment to a signal generator/analyzer.

FIG. 5 is a graph illustrating the impedance characteristics of water with varying frequency, according to the prior art.

FIG. 6 includes two graphical depictions illustrating the impedance characteristics of milk with varying frequency and different levels protein content according to the prior art.

FIG. 7 includes graphical depictions illustrating the impedance characteristics of human blood with varying frequencies, according to the prior art.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

As noted herein, this disclosure relates to systems and approaches for measuring an electromagnetic impedance characteristic of a fluid under test (FUT). In particular cases, a parallel plate sensor system is disclosed that is configured to characterize physical attribute(s) of a fluid by transmitting parallel electromagnetic field lines (at a specific frequency or over a range of frequencies) perpendicular to the flow of the fluid. The electromagnetic field may be generated by various means known in the art. Additionally, approaches for correlating the measured impedance at varying frequencies to physical attribute(s) of the FUT are known in the art, including, for example, analysis of variance (ANOVA) and various forms of neural networks including deep learning methods.

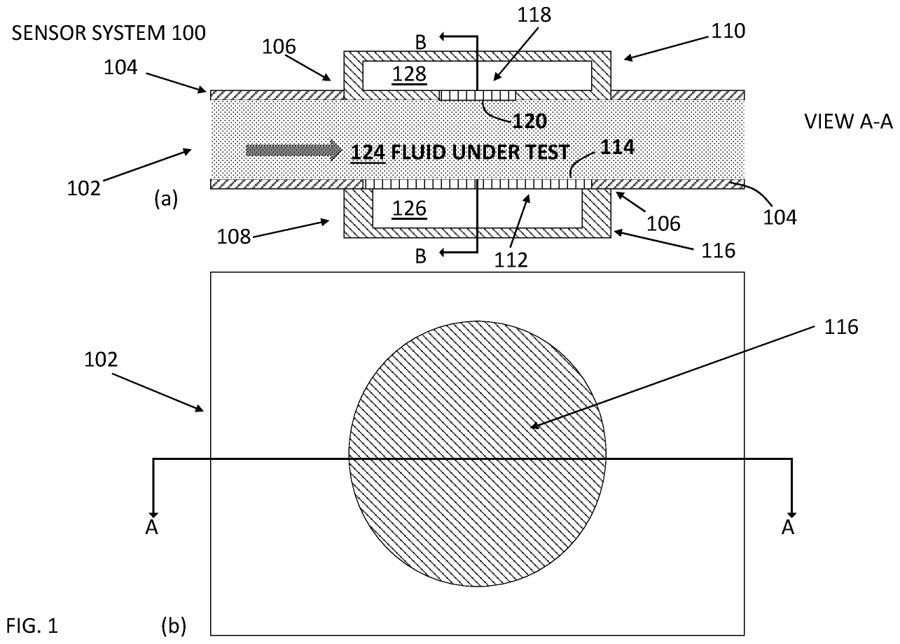

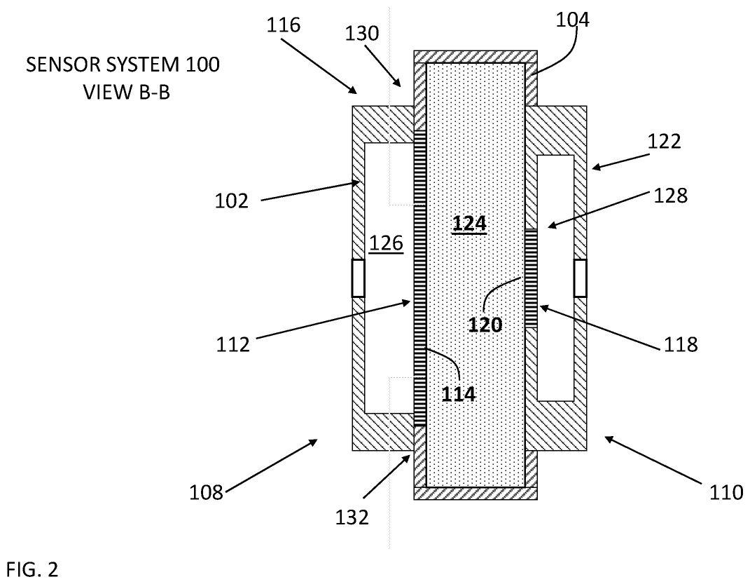

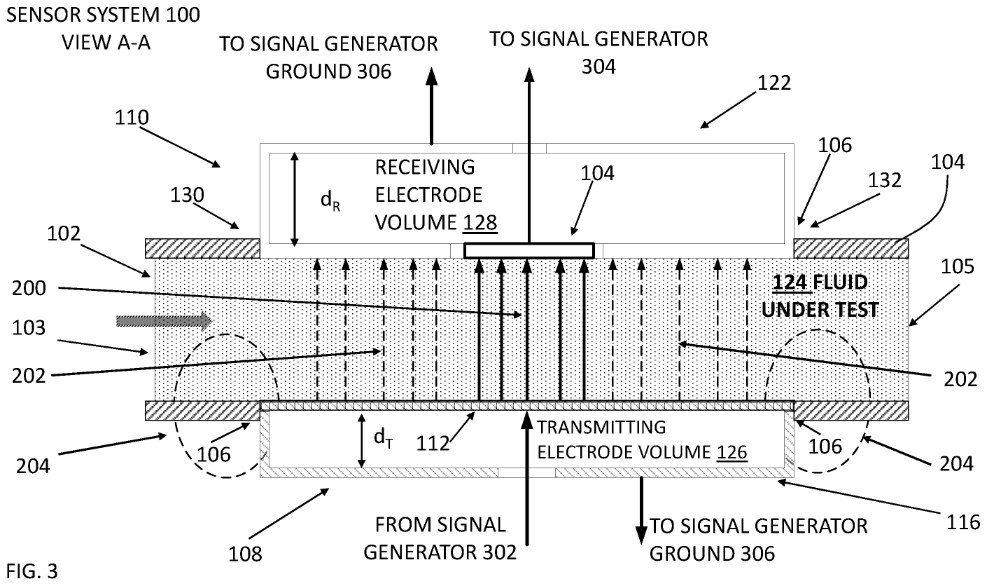

FIGS. 1-3 illustrate various perspectives of a sensor system (or simply, “system”) 100 according to various implementations. For example, FIG. 1(a) shows a side cross-sectional view of the system 100 (in plane A-A), FIG. 1(b) shows a top sectional view of the system 100, FIG. 2 shows a front sectional view of the system 100 (in plane B-B) and FIG. 3 presents a close-up view of the side cross-section of FIG. 1, further illustrating connections to other devices in the system. In various implementations, the sensor system 100 includes a fluid channel 102 having an inlet and an outlet. In some implementations, the fluid channel 102 has a rectangular cross-section (e.g., which can include a square cross-section), as illustrated in FIG. 1(b). In some cases, the fluid channel 102 is defined by a set of walls 104 (e.g., one or more walls) that have an inlet 103 and an outlet 105. In particular cases, the walls 104 also include pair of openings 106. In certain cases, the walls 104 defining the fluid channel 102 are either constructed of a non-conducting material or lined with a non-conducting material. In each of the openings 106 is an electrode assembly.

In a first one of the openings 106 is a transmitting electrode assembly 108, and in a second one of the openings 106 is a receiving electrode assembly 110. The transmitting electrode assembly 108 includes a transmitting electrode 112 having a transmitting surface 114, and a transmitting electrode backer ground plate 116 at least partially surrounding the transmitting electrode 112. The receiving electrode assembly 110 includes a receiving electrode 118 having a receiving surface 120, and a receiving electrode backer ground plate 122 at least partially surrounding the receiving electrode 118.

As can be seen in FIGS. 1(a), 2 and 3, the fluid channel 102 is located between the transmitting electrode assembly 108 and the receiving electrode assembly 110. In various implementations, the fluid channel 102 permits transverse flow of a fluid under test (FUT) 124 relative to both the transmitting electrode 112 and the receiving electrode 118.

In certain cases, the transmitting electrode 112 is substantially parallel with the receiving electrode 118 (e.g., within a margin of measurement error, such as up to several percent). In additional cases, the transmitting electrode 112 is aligned with the receiving electrode 118, such that the central point on each of the electrodes 112, 118 is aligned. In certain aspects, the transmitting surface 114 and the receiving surface 120 are each circular, and a diameter of the transmitting surface 114 is larger than a diameter of the receiving surface 120. In some implementations, the transmitting electrode backer ground plate 116 and the receiving electrode backer ground plate 122 are each circular, where a diameter of the transmitting surface 114 is equal to approximately the diameter of the receiving electrode backer ground plate 122. In other cases, the transmitting surface 114 and the receiving surface 120 are each rectangular (e.g., square), oval-shaped or elliptical-shaped.

In various implementations, the transmitting electrode assembly 108 and the receiving electrode assembly 110 are electrically isolated from one another and are also each electrically isolated from the walls 104. That is, in certain implementations, the transmitting electrode backer ground plate 116 is electrically grounded and insulated from the transmitting electrode 112. The transmitting electrode backer ground plate 116 extends from a plane formed by the transmitting electrode 112 and creates an electrically isolated volume proximate to the transmitting electrode 112. In additional implementations, the receiving electrode backer ground plate 122 is electrically grounded and insulated from the receiving electrode 118. The receiving electrode backer ground plate 122 extends from a plane formed by the receiving electrode 118 and creates an electrically isolated volume proximate to the receiving electrode 118. That is, the receiving electrode backer ground plate 122 can extend such that it has a coplanar surface with the receiving electrode 118. In various implementations, the diameter of the receiving electrode backer ground plate 122 is at least equal to the diameter of the transmitting electrode 112.

The volumes 126, 128 created between the backer ground plates 116, 122 and their respective electrodes 112, 118 enclose a volume proximate to the electrodes 112, 118 that induce a parasitic capacitance which affects the precision of the measured impedance. This parasitic capacitance can be controlled by the volumes 126, 128, as well as the electrical potential of the backer ground plates 116, 122, as discussed herein.

As noted herein, in particular aspects, a portion of each of the walls 104 proximate to the openings 106 is electrically non-conducting. In some example implementations, the electrically non-conducting portion of the walls 104 extends from an upstream edge 130 to a downstream edge 132 of the respective backer ground plates 116, 122.

One effect of the transmitting electrode 112 being larger (e.g., in diameter) than the receiving electrode 118, with the receiving electrode backer ground plate 122 having a surface that is coplanar with the receiving electrode 118 is shown in the schematic depiction of field lines 200, 202, 204 in FIG. 3. A set of electromagnetic field lines 202 travel from the transmitting electrode 112 to the area of the receiving electrode backer ground plate 122 that is coplanar with the receiving electrode 118, and provide a guarding field, such that the field lines 200 traveling from the transmitting electrode 112 directly to the receiving electrode 118 are perpendicular to the flow of the FUT 124. In some cases, fringing field lines 204 travel from the transmitting electrode 112 directly to transmitting electrode backer ground plate 116. These fringing effects contribute to the parasitic capacitance of the transmitting volume 126, along with field lines traversing the distances d_{T} and d_{R} directly from the transmitting electrode 112 and receiving electrode 118 to their respective backer ground plates 116, 122.

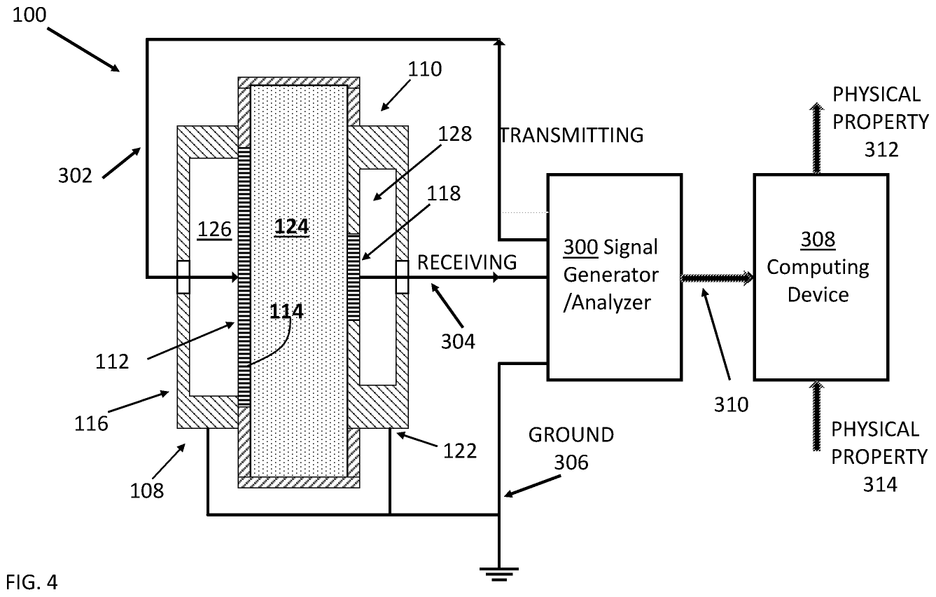

FIG. 4 illustrates electrical connections between the sensor system 100 (FIGS. 1-3) and a signal generator/analyzer 300. This figure illustrates the connections between the electrodes 112, 118 and the transmitting terminal 302 and receiving terminal 304 of the signal generator/analyzer 300. In various implementations, the system ground 306 of the signal generator/analyzer 300 is connected to the transmitting electrode backer ground plate 116 and the receiving electrode backer ground plate 122. The signal generator/analyzer 300 can include a generator component (not shown) that is configured to initiate transmission of a set of electromagnetic signals from the transmitting electrode 112, through the FUT 124, to the receiving electrode 118. In some cases, the electromagnetic signals are transmitted at a single frequency or over a range of frequencies. In particular aspects, the range of frequencies can include a range of frequencies within the range from approximately 100 Hertz (Hz) to approximately 100 mega-Hertz (MHz) as may be appropriate for the FUT of interest. The signal generator/analyzer 300 can also include an analyzer component (not shown) that is configured to detect a change in the set of electromagnetic signals from the transmitting electrode 112 to the receiving electrode 118.

As noted herein with respect to FIG. 3, the electromagnetic signals can define an electromagnetic field extending between the transmitting electrode 112 and the receiving electrode 118. In some cases, the electromagnetic field includes field lines 200, 202, 204, some of which extend between the transmitting electrode 112 and the receiving electrode 118. In particular, field lines 200 extend between the transmitting electrode 112 and the receiving electrode 118. These field lines 200 can be substantially parallel with one another and substantially perpendicular to the fluid flow. In additional implementations, field lines 202 are also substantially parallel with one another, as well as being parallel with field lines 200. As described herein, a volume of the electromagnetic field can be fixed based upon a diameter of the receiving electrode and a width of the fluid channel 102.

Returning to FIG. 4, a computing device 308 is shown coupled with the signal generator/analyzer 300. The computing device 308 is configured to determine a characteristic of the FUT 124 based upon a change in the set of electromagnetic signals from the transmitting electrode 112 to the receiving electrode 118. In various implementations, the computing device 308 is configured to determine the characteristic of the FUT 124 by performing processes including: a) determining a difference in an aspect of the set of electromagnetic signals; b) comparing the difference in the aspect to a predetermined threshold; and c) determining a characteristic of the FUT 124 based upon the compared difference. The computing device 308 can include any conventional computing architecture capable of performing processes as described herein and can be programmed to perform particular functions. The computing device 308 can include one or more processors and a memory, which may store program code and/or program logic for performing various functions according to embodiments.

As noted herein, and with continuing reference to FIG. 4, a number of conventional approaches for determining a characteristic of the FUT 124 based upon electromagnetic signals can be used in conjunction with the disclosed systems. In various implementations, the computing device 308 is used to either provide a correlation between spectrographic impedance data 310 provided by the signal generator/analyzer 300 to a physical property of the FUT 124 according to a previously established correlation algorithm 312, or use the inputted physical property/properties 314 of the FUT 124 to develop the correlation algorithm 312. As noted herein, the algorithm correlating the impedance spectrum with physical properties of the FUT may be accomplished using techniques known in the art such as analysis of variance (ANOVA) and various forms of neural networks including deep learning methods.

Referring to FIGS. 3 and 4, the transmitting electrode backer ground plate 116 and the receiving electrode backer ground plate 122 are connected to the system ground 306 from the signal generator/analyzer 300. In various embodiments, it is beneficial that the electric potential of the backer ground plates 116 and 122 be equal. The parasitic capacitance of the volume created between the respective backer ground plates and electrodes (volumes 126 and 128) are affected by the potential of both the backer ground plate 116, 122 and the transmitting and receiving electrodes 112, 118.

Control of the parasitic capacitance in volumes 126 and 128 can be very beneficial. The parasitic capacitance on the transmitting electrode assembly 108 affects the impedance that the signal generator/analyzer 300 must overcome. The parasitic capacitance on the receiving electrode assembly 110 affects the signal-to-noise ratio of the signal received by the signal generator/analyzer 300. Minimizing the effects of both can be accomplished by three steps. The first step is to control the electric potential of the two backer ground plates 116 and 122 such that those potentials are approximately identical. The size and separation of the two backer ground plates 116 and 122 prevent the potentials from being identical due to the effects of the different values of the parasitic capacitances in volumes 126 and 128. Regardless of the small variations in the potential between the backer ground plates 116 and 122, this design enables the parasitic capacitances to be better defined and maintained. The second step is the selection of the values for the air gap of distance d_{T} for the transmitting electrode volume 126 and of distance d_{R} for the receiving electrode volume 128 by using a computational tool such as Comsol's Multiphysics as described herein. The third step is the selection of the medium that fills volumes 126 and 128. The value of the parasitic capacitance is affected by the dielectric value of the medium in the volumes. A higher value of dielectric means that for everything else being the same, the parasitic capacitance will be higher. Therefore, it is highly beneficial that the material with the lowest dielectric be used. Since next to a vacuum air has the lowest dielectric, air is the medium of choice in various implementations.

The conductive backer ground plates 116, 122 are designed to help to control the parasitic capacitances generated by the electric field lines 200 (as well as field lines 202) that traverse between the electrodes 112, 118. These backer ground plates 116, 122 can be used to control the electric field lines 200, 202 between the electrodes 112, 118 as they pass through the FUT 124.

In various implementations, as the transmitted electromagnetic signal is scanned over a range of frequencies, the amplitude of the electric potential of the signal remains approximately constant and controls the potential of the transmitting electrode ground plate 116. The enclosed volume 126 created by the transmitting electrode backer ground plate 116 at least partially surrounding the transmitting electrode 112 helps to mitigate the parasitic capacitance between the transmitting electrode backer ground plate 116 and the transmitting electrode 112. In some cases, the volume 126 is designed in terms of distance d_{T} between the transmitting electrode backer ground plate 116 and the transmitting electrode 112 (e.g., using Comsol's Multiphysics or another similar tool), to limit the effects of the parasitic capacitance on the impedance measurements.

The receiving electrode 118 and its corresponding backer ground plate 122 act in a different manner The signal arriving at the receiving electrode 118 after passing through the FUT 124 varies with the material type (e.g., fluid characteristics and frequency). As the transmitted signal from transmitting electrode 112 passes through the FUT 124, the strength of the signal (magnitude) is attenuated, and the phase relation is changed. As such, the potential of the signal and its phase relative to the transmitted signal is quite variable (by fluid type), and unknown a priori. The parasitic capacitance due to the field between the receiving electrode 118 and its backer ground plate 122 has a larger effect on the measurement (when compared with the transmitting electrode 112 and its backer ground plate 116) due to the attenuation of the transmitted signal at the receiving electrode 118. Therefore, the ability to reduce and control the parasitic capacitance for the receiving electrode 118 can be significant to the quality of the data measured. This control can be achieved by the combination of controlling the potential of the receiving electrode backer ground plate 122 and by designing the volume 128 and distance dR enclosed by the receiving electrode 118 and the backer ground plate 122, e.g., based upon a computation of the system impedance with a computational tool such as Comsol's Multiphysics or the like.

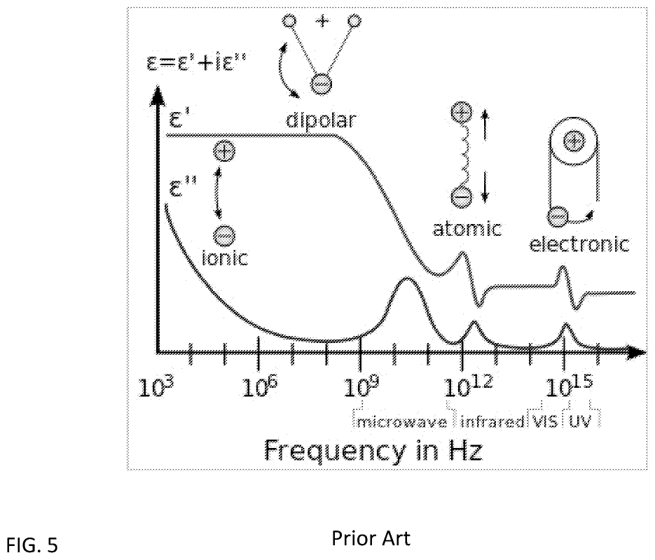

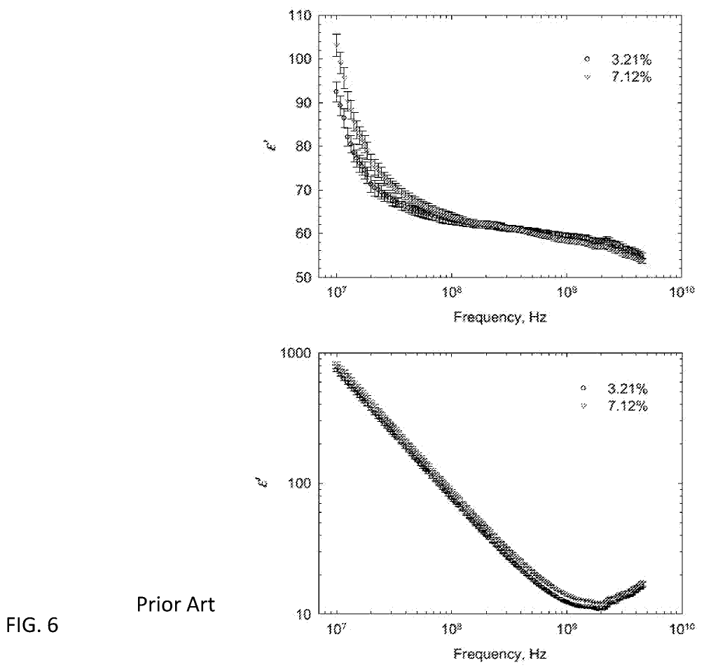

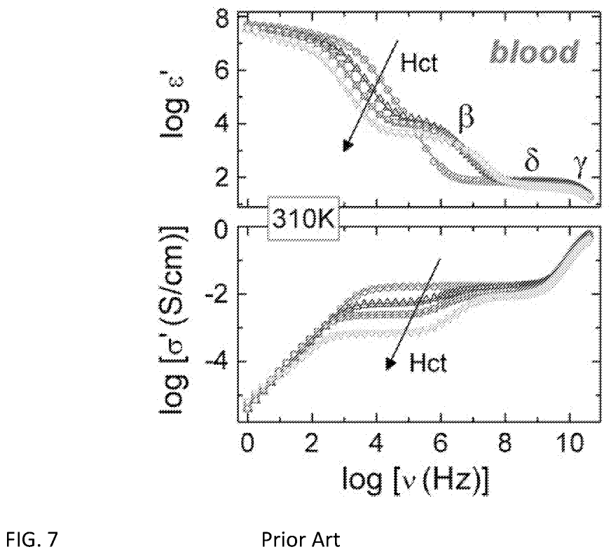

FIGS. 5, 6, and 7 include graphical depictions illustrating observed variations in the spectrographic impedance of an inorganic fluid (water, FIG. 5), an organic fluid (milk, FIG. 6) and a biological fluid (blood, FIG. 7). By using precise values of impedance over a range of frequencies specific to the FUT of interest, and applying one or more of the various means in the art (e.g. ANOVA and deep learning) to make correlations between the spectrographic impedance and desired physical property/properties of the FUT, an algorithm may be developed to provide a measure of the desired physical property during an in-process monitoring of the FUT.

The following documents are each incorporated by reference herein in their entirety: 1) Bertemes-Filho, P., et al; “Bioelectrical Impedance Analysis for Bovine Milk: Preliminary Results” Journal of Physics: Conference Series Vol 224 No.1, 2010; 2) Grossi, M., et al: “Fast and Accurate Determination of Olive Oil Acidity by Electrochemical Impedance Spectroscopy” IEEE Sensors Journal 2014, 14 (9) pp.2947-2954; 3) Zhu, Z., et al; “Dielectric Properties of Raw Milk as Functions of Protein Content and Temperature” Food Bioprocess Technology (2015) 8:670-680; 4) Das, S., et al; “Milk Adulteration and Detection: A Review” Sensor Letters Vol 14, 1-18 2016; 5) Ziatev, T. and Vasilev, M.: “Contactless Methods for Quality Evaluation of Dairy Products” Applied Research in Technics, Technologies, and Education Vol. 4, No. 1, 2016; 6) Grossi, M. and Ricco, B.; “Electrical Impedance Spectroscopy (EIS) for Biological Analysis and Food Characterization: A Review” Journal of Sensors and Sensor Systems Vol. 6 pp. 303-325, 2017; 7) Dielectric Spectroscopy, Wikipedia, available at: https://en.wikipedia.org/wiki/Dielectric_spectroscopy, attributed to Dr. Kenneth Mauritz; and 8) Wolf, M., et al; “Broadband Dielectric Spectroscopy on Human Blood” Biochinica et Biophysica Acta Vol 1810, No. 8 Aug. 2011 PP 727-740.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random-access memory or both. Components of a computer include a processor for executing instructions and one or more memory devices for storing instructions and data.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for measuring an electromagnetic impedance characteristic of a fluid under test (FUT), the system comprising:
a transmitting electrode assembly comprising:
a transmitting electrode having a transmitting surface; and
a transmitting electrode backer ground plate at least partially surrounding the transmitting electrode;
a receiving electrode assembly comprising:
a receiving electrode having receiving surface, wherein the receiving surface is smaller than the transmitting surface; and
a receiving electrode backer ground plate at least partially surrounding the receiving electrode; and
a fluid channel between the transmitting electrode assembly and the receiving electrode assembly, the fluid channel permitting transverse flow of the FUT relative to both the transmitting electrode and the receiving electrode.

2. The system of claim 1, wherein the transmitting electrode is substantially parallel with the receiving electrode, and wherein the transmitting electrode is aligned with the receiving electrode.

3. The system of claim 1, wherein the transmitting electrode backer ground plate is electrically grounded and insulated from the transmitting electrode, and wherein the transmitting electrode backer ground plate extends from a plane formed by the transmitting electrode and creates an electrically isolated volume proximate to the transmitting electrode,
wherein the receiving electrode backer ground plate is electrically grounded and insulated from the receiving electrode, and wherein the receiving electrode backer ground plate extends from a plane formed by the receiving electrode and coplanar with that plane creating an electrically isolated volume proximate to the receiving electrode.

4. The system of claim 1, wherein the transmitting surface and the receiving surface are each circular, and wherein a diameter of the transmitting surface is larger than a diameter of the receiving surface, wherein the transmitting electrode conductive backer ground plate and the receiving electrode conductive backer ground plate are each circular, and wherein the diameter of the transmitting surface is equal to approximately a diameter of the receiving electrode conductive backer ground plate.

5. (canceled)

6. The system of claim 1, wherein the fluid channel is defined by a set of walls, wherein the set of walls includes a pair of openings, and wherein the transmitting electrode assembly is located in a first one of the pair of openings and the receiving electrode assembly is located in a second one of the pair of openings,
wherein a portion of each of the walls proximate to the pair of openings is electrically non-conducting, wherein the electrically non-conducting portion of each of the walls extends from an upstream extreme edge to a downstream extreme edge of the transmitting electrode backer ground plate and the receiving electrode backer ground plate, respectively, and
wherein the fluid channel has an inlet, and an outlet opposing the inlet, wherein the FUT flows from the inlet to the outlet, and wherein the transmitting electrode assembly is integral and conforming to one of the walls, and the receiving electrode assembly is integral and conforming to an opposite one of the walls.

7. (canceled)

8. (canceled)

9. The system of claim 1, wherein the transmitting surface and the receiving surface are each rectangular, elliptical, or oval-shaped, and wherein a major dimension of the transmitting surface is larger than a major dimension of the receiving surface.

10. The system of claim 1, wherein the FUT comprises a liquid, a gas, or an organic fluid.

11. (canceled)

12. The system of claim 1, wherein the transmitting electrode assembly comprises at least one additional transmitting electrode and wherein the receiving electrode assembly comprises at least one additional receiving electrode, and wherein respective electrodes in the transmitting electrode assembly are configured to operate at a single frequency or at subsets of the range of frequencies appropriate for the FUT of interest and respective electrodes in the receiving electrode assembly are configured to operate at the single frequency or at the distinct frequencies.

13. The system of claim 1, further comprising a signal generator/analyzer coupled with the transmitting electrode and the receiving electrode, the signal generator/analyzer comprising:
a generator component configured to initiate transmission of a set of electromagnetic signals from the transmitting electrode, through the FUT, to the receiving electrode; and
an analyzer component configured to detect a change in the set of electromagnetic signals from the transmitting electrode to the receiving electrode.

14. The system of claim 13, wherein the set of electromagnetic signals are transmitted within a frequency range of approximately 100 Hertz to approximately 100 mega-Hertz as may be appropriate for the FUT of interest.

15. The system of claim 13, further comprising a computing device coupled with the signal generator/analyzer, wherein the computing device is configured to determine a characteristic of the FUT based upon a change in the set of electromagnetic signals from the transmitting electrode to the receiving electrode.

16. The system of claim 15, wherein determining the characteristic of the FUT comprises:
determining a difference in an aspect of the set of electromagnetic signals;
comparing the difference in the aspect to a predetermined threshold; and
determining a characteristic of the FUT based upon the compared difference.

17. The system of claim 15, wherein the set of electromagnetic signals define an electromagnetic field including field lines extending between the transmitting electrode and the receiving electrode, and wherein a volume of the electromagnetic field is fixed based upon a diameter of the receiving electrode and a width of the fluid channel,
wherein the field lines in the electromagnetic field are substantially parallel with one another.

18. (canceled)

19. A method of measuring an electromagnetic impedance characteristic of a fluid under test (FUT), the method comprising:
providing a system comprising:
a transmitting electrode assembly comprising:
a transmitting electrode having a transmitting surface; and
a transmitting electrode backer ground plate at least partially surrounding the transmitting electrode;
a receiving electrode assembly comprising:
a receiving electrode having receiving surface, wherein the receiving surface is smaller than the transmitting surface; and
a receiving electrode backer ground plate at least partially surrounding the receiving electrode; and
a fluid channel between the transmitting electrode assembly and the receiving electrode assembly;
flowing the FUT through the fluid channel;
transmitting a set of electromagnetic signals from the transmitting electrode, through the FUT, to the receiving electrode while flowing the FUT through the fluid channel; and
detecting a change in the set of electromagnetic signals from the transmitting electrode to the receiving electrode.

20. The method of claim 19, wherein the set of electromagnetic signals are transmitted within a frequency range of approximately 100 Hertz to approximately 100 mega-Hertz.

21. The method of claim 19, further comprising determining a characteristic of the FUT based upon a change in the set of electromagnetic signals from the transmitting electrode to the receiving electrode.
wherein determining the characteristic of the FUT comprises:
determining a difference in an aspect of the set of electromagnetic signals;
comparing the difference in the aspect to a predetermined threshold; and
determining a characteristic of the FUT based upon the compared difference.

22. (canceled)

23. The method of claim 21, wherein the set of electromagnetic signals define an electromagnetic field including field lines extending between the transmitting electrode and the receiving electrode, and wherein a volume of the electromagnetic field is fixed based upon a diameter of the receiving electrode and a width of the fluid channel,
wherein the field lines in the electromagnetic field are substantially parallel with one another.

24. (canceled)

25. The method of claim 23, wherein parasitic capacitances of enclosed capacitive volumes defined by the transmitting electrode backer ground plate and the receiving electrode backer ground plate are dictated by selection of d_{T} and d_{R} to isolate and control effects of field lines which emanate from both the transmitting electrode and the receiving electrode to the backer ground plates, and field lines that pass through the FUT and go to the backer ground plates,
wherein a medium within the enclosed capacitive volumes comprises air.

26. (canceled)

27. The method of claim 19, wherein the transmitting electrode and the receiving electrode are in electrical conducting contact with the FUT, or are in non-electrical conducting contact with the FUT.

28. (canceled)
